(19) United States
(12) Patent Application Publication
(10) Pub. No.: US 2009/0301671 A1
(43) Pub. Date: Dec. 10, 2009

(54) WINDOW COVER FOR VEHICLES

(76) Inventor: Dino Locklear, Baltimore, MD (US)

Correspondence Address: MICHAEL RIES, 318 PARKER PLACE, OSWEGO, IL, 60543, US

(21) Appl. No.: 12/134,278

(22) Filed: Jun. 6, 2008

(51) Int. Cl. B60J 11/08

(52) U.S. Cl. 160/370.21

(57) ABSTRACT

Disclosed is a window cover for protecting a window of a vehicle during inclement winter weather. The window cover includes a flexible sheet for detachably covering the window. Further, the window cover includes a plurality of magnets configured on the flexible sheet. The plurality of magnets is capable of being securely attached to a first portion of the vehicle for enabling the flexible sheet to detachably cover the window. Furthermore, the window cover includes a plurality of suction devices configured on the flexible sheet. The plurality of suction devices is capable of being securely attached to a second portion of the vehicle for enabling the flexible sheet to detachably cover the window.

### FIELD OF THE INVENTION

The present invention generally relates to a shielding system for a window of a vehicle, and more specifically, to a window cover for protecting the window of the vehicle against accumulation of snow and ice thereon during inclement winter weather.

### BACKGROUND OF THE INVENTION

It is well known that during winter, snow and ice commonly accumulate on a window of a vehicle, such as a car, a truck, a van and the like, when the vehicle is parked out-of-doors. The window of the vehicle, as used herein, may refer either to a windshield, a rear window or a side window of the vehicle. After the accumulation of snow and ice on the window, and more specifically on the windshield and the rear window, it is usually a troublesome and a time-consuming task to remove a sufficient amount of the accumulated snow and ice to permit sufficient visibility prior to or while driving. Further, it becomes tedious when frozen snow and thick ice accumulate on the windshield and/or on other windows of the vehicle.

Accordingly, many commercially available scrapers have been used for removing accumulated snow and ice from windows of vehicles that may be parked out-of-doors. However, use of the commercially available scrapers has always been a time-consuming, a difficult and a painstaking task as a user needs to scrape the accumulated snow and ice from over the windows while standing in cold weather for a long time. Further, a lot of care is required while scraping or chipping away of the accumulated snow and ice using a scraper in order to prevent damage to the windows of the vehicles.

To circumvent problems associated with the use of the commercially available scrapers, various shielding systems including conventional covers have been employed to cover and protect windows of vehicles in order to prevent the accumulation of snow and ice thereon. A suitable example of such a conventional cover may include, but is not limited to, a large piece of cardboard that may be placed over an outside surface of a vehicle's window when snow or icing conditions are anticipated. Alternatively, pieces of fabric, such as carpet remnants, may be placed over the outside surface of the window for protection purposes. Subsequent to placing the above-described conventional covers over an outside surface of a window of a vehicle during inclement winter weather, a gentle pulling-off of the conventional covers from the window before the vehicle is to be driven serves to clear enough snow and ice off the window to permit safe driving.

However, such conventional shielding systems have not been provided with a proper means for effectively and detachably covering a window of a vehicle during inclement winter weather. An ineffective and an improper covering may result in either slipping-off or an improper alignment of the conventional shielding systems over the window. Further, strong winds that may be accompanied by storms in the inclement winter weather, often lead to blowing-off of the conventional shielding systems from the vehicle due to the ineffective and the improper covering. Further, materials employed for making these conventional shielding systems, such as cardboard, may become inundated in wet snow, icing or sleet conditions, and thereafter may tear in pieces during removal from the window of the vehicle.

Accordingly, there exists a need for an effective shielding system for protecting a window, and more specifically, for protecting a windshield and/or a rear window, of a vehicle, against ice and snow during inclement winter weather. Further, the shielding system should be capable of detachably covering the window in an easy, and a convenient manner, such that, after use, the shielding system may easily be removed from the window without causing any damage thereto.

### SUMMARY OF THE INVENTION

In view of the foregoing disadvantages inherent in the prior art, the general purpose of the present invention is to provide an effective shielding system for protecting a window of a vehicle, which includes all the advantages of the prior art, and overcomes the drawbacks inherent therein.

Accordingly, an object of the present invention is to provide an effective shielding system for protecting a window of a vehicle, against snow and ice during inclement winter weather.

Another object of the present invention is to provide an effective shielding system that is capable of detachably covering a window of a vehicle in an easy, and a convenient manner, such that, after use, the shielding system may easily be removed from the window without causing any damage thereto.

In light of the above objects, the present invention discloses an effective shielding system in the form of a window cover for protecting a window of a vehicle during inclement winter weather. The window cover comprises a flexible sheet for detachably covering the window. The flexible sheet comprises a first surface facing the window, and a second surface that is capable of being exposed to the inclement winter weather. Further, the window cover comprises a plurality of magnets configured on the first surface of the flexible sheet. The plurality of magnets is capable of being securely attached to a first portion of the vehicle for enabling the flexible sheet to detachably cover the window. Furthermore, the window cover comprises a plurality of suction devices configured on the first surface of the flexible sheet. The plurality of suction devices is capable of being securely attached to a second portion of the vehicle for enabling the flexible sheet to detachably cover the window.

This together with other embodiments of the present invention, along with the various features of novelty that characterize the present invention, are pointed out with particularity in the claims annexed hereto and form a part of this disclosure. For a better understanding of the present invention, its operating advantages, and the specific objects attained by its uses, reference should be made to the accompanying drawings and the descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1 depicts a perspective view of a window cover secured to a window of a vehicle, according to an exemplary embodiment of the present invention;

FIG. 2 depicts a perspective view of the window cover partially secured to the window of the vehicle, according to an exemplary embodiment of the present invention;

FIG. 3 depicts a side view of the window cover secured to the window of the vehicle, according to an exemplary embodiment of the present invention; and

FIG. 4 depicts a perspective view of the window cover having a plurality of securing straps, according to an embodiment of the present invention.

Like reference numerals refer to like parts throughout the description of the drawings.

### DETAILED DESCRIPTION OF THE INVENTION

The exemplary embodiments described herein detail for illustrative purposes are subject to many variations in structure and design. It should be emphasized, however, that the present invention is not limited to a particular window cover, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The use of terms, “including,” or “comprising,” and variations thereof herein is meant to encompass the items listed thereafter and equivalents thereof as well as additional items. Further, the terms “a” and “an” herein do not denote a limitation of quantity, but rather denote the presence of at least one of the referenced item. Furthermore, the terms “first,” “second,” and the like, herein do not denote any order, quantity, or importance, but rather are used to distinguish one element from another.

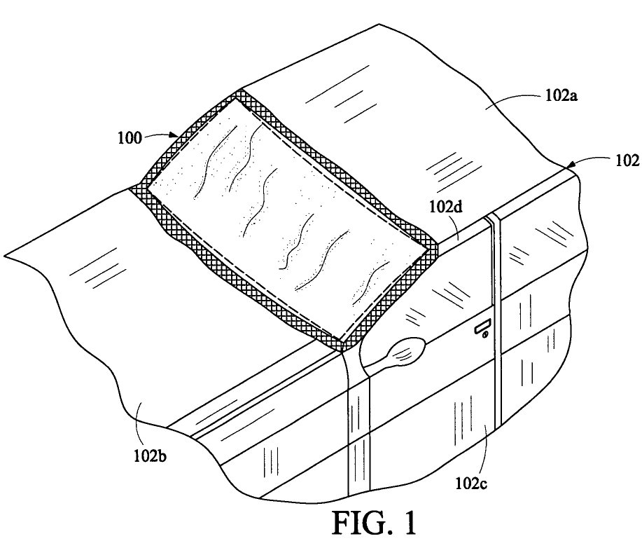

The present invention relates to a window cover for protecting a window of a vehicle during inclement winter weather. More specifically, the window cover provides protection to the window against snow and ice during the inclement winter weather. As used herein, the term, ‘vehicle’ may refer to a car, a truck, a van, and such similar vehicles. The window cover, as disclosed herein, is capable of detachably covering the window, and more specifically, a windshield and/or a rear window of the vehicle in order to provide a proper protection against snow and ice. The window cover of the present invention is explained in detail in conjunction with FIGS. 1 to 4.

FIG. 1 depicts a perspective view of a window cover 100 secured to a window (not shown) of a vehicle 102, according to an exemplary embodiment of the present invention. For the purpose of this description, the vehicle 102 is a car; and includes a roof 102a, a hood 102b, and side doors, such as a side door 102c. The side doors include metallic bodies, such as a metallic body 102d of the side door 102c.

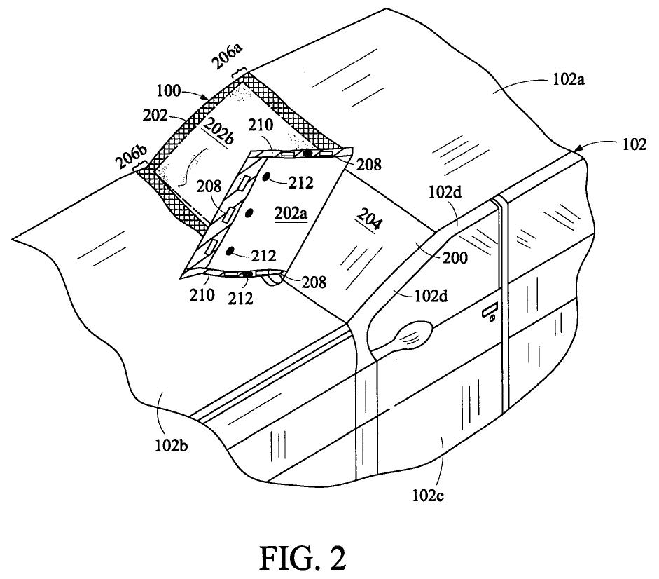

As depicted in FIG. 1, the window cover 100 is secured to a windshield (not shown) of the vehicle 102 for protection against snow and ice during inclement winter weather. The term, ‘windshield’, as used herein, refers to a front window of the vehicle 102. Without departing from the scope of the present invention, it should be understood that the window cover 100 may also be used to cover and thereby protect rear window (not shown) of the vehicle 102. Additionally, the window cover 100 may be used to protect one or more other windows (not shown) of the vehicle 102. The term, ‘one or more other windows’ may refer to side windows of the vehicle 102. As depicted in FIG. 1, it should be apparent that the window cover 100 is purposely made to cover only the window of the vehicle 102. The window cover 100 with components thereof is further explained in detail in conjunction with FIG. 2.

FIG. 2 depicts a perspective view of the window cover 100 partially secured to the window, such as a window 200, of the vehicle 102, according to an exemplary embodiment of the present invention. For the purpose of this description, the window cover 100 is shown to be partially secured to the window 200 in order to depict various components of the window cover 100.

As depicted in FIG. 2, the window cover 100 includes a flexible sheet 202 for detachably covering the window 200. The flexible sheet 202 includes a first surface 202a and a second surface 202b. The first surface 202a faces the window 200. More specifically, the first surface 202a faces an outside surface 204 of the window 200. The second surface 202b is a surface, which is capable of being exposed to the inclement winter weather.

The flexible sheet 202, as disclosed herein, is made of a material that imparts a tear-resistant property and a water-resistant property to the flexible sheet 202. Due to the tear-resistant and the water-resistant properties, the flexible sheet 202 is a structurally strong sheet that is capable of withstanding extreme winter weather conditions. Further, the flexible sheet 202 is resistant to snow and ice, and therefore, the flexible sheet 202 is capable of efficiently protecting the window 200 of the vehicle 102 against snow and ice. More specifically, the flexible sheet 202 is a sheet of tarp (tarpaulin). A tarp is a large sheet of a strong, a flexible, and a water-resistant material. Suitable examples of such a material include, but are not limited to, canvas and polyester. Further, such a material may be coated with plastics, such as latex or polyvinyl chloride (PVC). Even more specifically, a multi-layered sheet of tarp may be used as the flexible sheet 202 of the present invention.

The flexible sheet 202 may be designed in a dimension sufficiently large enough to completely cover the window 200. For the purpose of this description, the flexible sheet 202 has a specific dimension that is characterized by a length of about 4 feet, a width of about 27 to about 30 inches, and a height of about 5 feet. Further, the flexible sheet 202 may have an extended top portion 206a and an extended bottom portion 206b of about 5 to 6 inches each, for covering or overlapping with adjacent outside portions (not shown) of the roof 102a and the hood 102b, respectively. Furthermore, side portions (not shown) of the flexible sheet 202, as signified by about 2 to 3 inches of the flexible sheet 202 from either side (not shown) thereof, may cover or overlap with adjacent outside portions (not shown) of the metallic bodies, such as the metallic body 102d, of the side doors, such as the side door 102c.

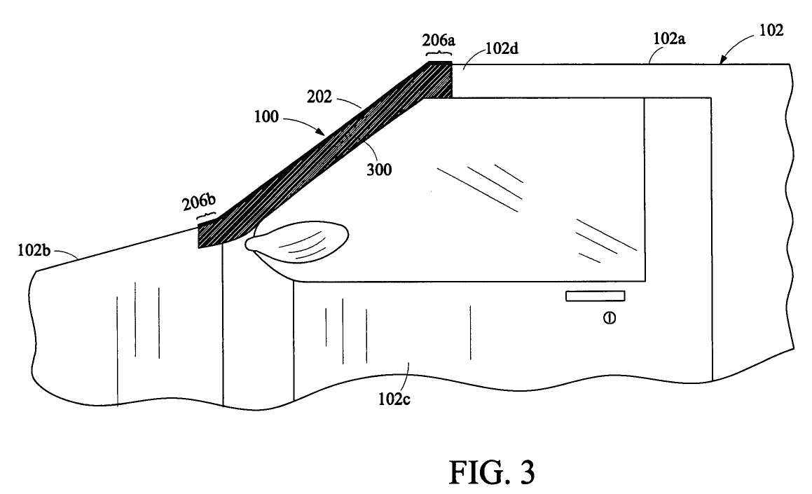

Referring to FIG. 3 that depicts a side view of the window cover 100 secured to the window 200 of the vehicle 102, it should be understood that the window cover 100 may be secured to the vehicle 102, such that, the bottom portion 206b of the flexible sheet 202 may also cover a wiper device (not shown) of the vehicle 102 that is configured in between the window 200 and the hood 102b. Therefore, it should be apparent that the window cover 100 may be aligned over the window 200 so that the top portion 206a of the flexible sheet 202 extends beyond the window 200 and onto the adjacent outside portion of the roof 102a; and the bottom portion 206b extends beyond the window 200 onto the adjacent outside portion of the hood 102b. In this manner, protection of the window 200 is extended so as to include the outside portions of the roof 102a and the hood 102b, which are adjacent to the window 200. Similarly, the side portions, such as side portions 300, of the flexible sheet 202 extend beyond the window 200 to cover or overlap with the adjacent outside portions of the metallic bodies, such as the metallic body 102d, of the side doors, such as the side door 102c.

Furthermore, the flexible sheet 202 may be designed in a standard or a custom shape depending on shape of the window 200 of the vehicle 102. It should be understood that the specific dimension of the flexible sheet 202 is solely characterizing dimension of the window cover 100. Therefore, it should be understood that the window cover 100 may be designed in a standard or a custom shape and a dimension depending on standard shapes and dimensions of windows, such as the window 200, of different types of vehicles, such as the vehicle 102 of the present invention.

Additionally, the flexible sheet 202 may be designed using a specific color based on a manufacturer's preference. Alternatively, the flexible sheet 202 may be designed using a color, which is aesthetically appealing to a user.

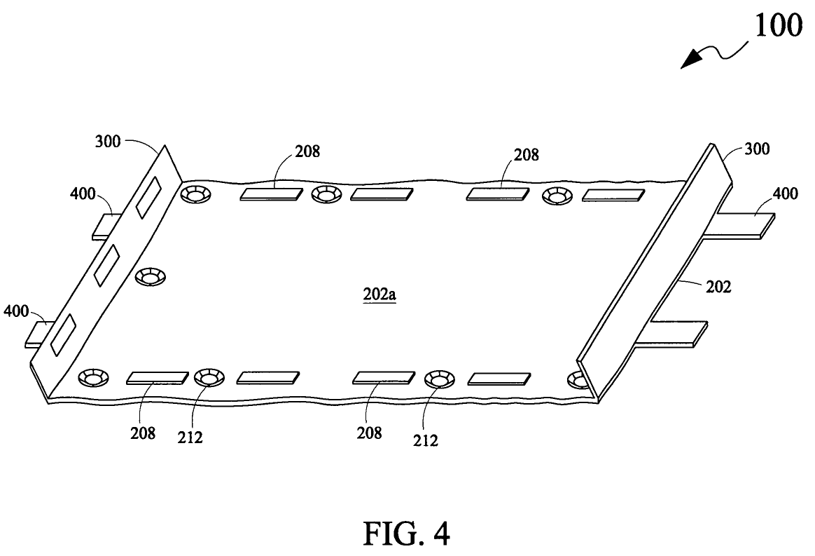

Referring again to FIG. 2 and FIG. 3, the window cover 100 further includes a plurality of magnets 208 (hereinafter referred to as ‘magnets 208’) configured on the first surface 202a of the flexible sheet 202. More specifically, the window cover 100 may include about 12 to 14 of such magnets 208 weighing about 10 Ounces. The magnets 208 may be configured on the first surface 202a within confines of the top portion 206a and the bottom portion 206b of the flexible sheet 202. However, it should be apparent that the magnets 208 may also be configured on the first surface 202a in order to be aligned along perimeter of a peripheral fold 210 of the flexible sheet 202. It should be apparent that the magnets 208 may also be configured on the first surface 202a within confines of the side portions 300 of the flexible sheet 202, as depicted in FIG. 4. Further, it should be understood that dimension of the peripheral fold 210 on the either side of the flexible sheet 202 may be comparable to that of the side portions 300 of the flexible sheet 202.

For the purpose of this description, the magnets 208, as configured on the first surface 202a, are spaced-apart at a distance from each other, and further, are capable of securely attaching to a first portion (not shown) of the vehicle 102. The first portion of the vehicle 102 may refer to an outside portion (not shown) of the roof 102a, and more specifically, the first portion may be an outside portion of the roof 102a, which is adjacent to the top portion 206a of the flexible sheet 202. Additionally, the first portion may refer to an outside portion (not shown) of the hood 102b, and more specifically, the first portion may be an outside portion of the hood 102b, which is adjacent to the bottom portion 206b of the flexible sheet 202. Accordingly, it should be understood that the magnets 208 enable the top portion 206a and the bottom portion 206b of the flexible sheet 202 to securely attach to the outside portion of the roof 102a and the outside portion of the hood 102b, respectively.

Without departing from the scope of the present invention, it should also be understood that the first portion of the vehicle 102 may also refer to the outside portions of the metallic bodies, such as the metallic body 102d, of the side doors, such as the side door 102c, which is configured adjacent to the window 200 of the vehicle 102.

It should be understood that the magnets 208 are capable of attaching to the vehicle 102 through metallic body (not shown) or other metallic parts thereof, such as the roof 102a, the hood 102b, and the metallic bodies of the side doors. Accordingly, the said property of the magnets 208 enables the flexible sheet 202, and therefore the window cover 100, to detachably cover the window 200 of the vehicle 102 for protection purposes.

The magnets 208 may be designed in any standard or custom shape and a dimension based on a manufacturer's preference. For the purpose of this description, the magnets 208 are rectangular in shape. Further, the magnets 208 may be stitched either within or on the peripheral fold 210 to configure in a specific arrangement along the perimeter of the peripheral fold 210 of the flexible sheet 202. Alternatively, the magnets 208 may be configured on the first surface 202a using adhesives that are known in the art for fixing magnets, such as the magnets 208, on to a surface, such as the first surface 202a of the flexible sheet 202.

As depicted in FIG. 2 and FIG. 4, the window cover 100 further includes a plurality of suction devices 212 (hereinafter referred to as ‘suction devices 212’) configured on the first surface 202a of the flexible sheet 202. More specifically, the window cover 100 may include about 6 of such suction devices 212. The suction devices 212 include suction cups (not shown) and axles (not shown) that are mounted onto the flexible sheet 202 to accommodate positioning of the suction cups as required. It should be understood that the suction devices 212 may be secured within confines of the peripheral fold 210 of the flexible sheet 202. Further, the suction devices 212 may be configured on the first surface 202a in a random arrangement, as depicted in FIG. 4.

For the purpose of this description, the suction devices 212, as configured on the first surface 202a, are spaced-apart at a distance from each other, and further, are capable of securely attaching to a second portion (not shown) of the vehicle 102. The second portion of the vehicle 102 may refer to an outside portion of the window 200. More specifically, the second portion of the vehicle 102 may refer to a portion of the outside surface 204 of the window 200. Even more specifically, the portion of the outside surface 204 of the window 200 refers to an outside portion of glass of the window 200. Further, the suction devices 212 are configured on the first surface 202a of the flexible sheet 202, such that, the suction devices 212 are capable of being aligned in a direct contact with the glass of the window 200 in order to securely attach to the window 200 of the vehicle 102.

Additionally, and without departing from the scope of the present invention, the second portion may also be an outside portion of the roof 102a and/or an outside portion of the hood 102b. Accordingly, it should be understood that the suction devices 212 may also be configured on the first surface 202a of the flexible sheet 202 within the confines of the top portion 206a and/or the bottom portion 206b of the flexible sheet 202. More specifically, it should be understood that such a configuration enables a secure attachment of suction devices, such as the suction devices 212, to a vehicle, such as the vehicle 102, which may have a fiber glass body.

For the purpose of this description, the suction devices 212 may be stitched or sewn on the first surface 202a of the flexible sheet 202. Alternatively, the suction devices 212 may be configured on the first surface 202a of the flexible sheet 202 using adhesives that are known in the art for fixing suction devices, such as the suction devices 212, on to a surface, such as the first surface 202a.

Without departing from the scope of the present invention, it should be understood that each of the suction devices 212 may be adhered to a hook (not shown), such that, the each of the suction devices 212 is adhered to one end of the hook and is capable of securely attaching to the second portion of the vehicle 102, and the other end of the hook is configured onto the flexible sheet 202. Such a configuration enables the suction devices 212 to securely attach to the vehicle 102 either through the side doors, or through the side windows of the vehicle 102, or through an outside portion of the roof 102a, or an outside portion of the hood 102b.

It should be understood that the suction devices 212 are capable of attaching to the second portion of the vehicle 102 by generating vacuum in between the suction cups and the second portion. Accordingly, the said property of the suction devices 212 enables the flexible sheet 202, and therefore the window cover 100, to detachably cover the window 200 of the vehicle 102 for protection purposes.

The suction devices 212 may be designed in any standard or custom shape and a dimension based on a manufacturer's preference. More specifically, the suction devices 212 with suction cups may have concave surfaces, which when placed against a flat surface, such as the outside surface 204 of the window 200, helps creating a small vacuum between the suction cups and the flat surface. The small vacuum holds the suction devices 212 in place. Accordingly, it should be understood that the suction devices 212 are sufficiently pliable so that they can be pressed against the flat surface. This may cause the concave surfaces of the suction cups to deform and flatten against the flat surface. Further, it should be understood that the suction devices 212 are made of a resilient material, which enables the suction devices 212 to return to original shapes after being removed from the flat surface.

As depicted in FIG. 4, the window cover 100 may optionally include a plurality of securing straps 400 (hereinafter referred to as ‘straps 400’. The straps 400, in addition to the magnets 208 and the suction devices 212, enable the flexible sheet 202 to detachably cover the window 200 of the vehicle 102. More specifically, the straps 400 may securely attach to the side doors of the vehicle 102 to maintain a proper alignment of the window cover 100 over the window 200.

With the flexible sheet 202 detachably covering the window 200, the straps 400 may be secured to the vehicle 102 by opening the side doors or the side windows that are configured adjacent to the window 200. Such an arrangement may be achieved by folding end regions (not shown) of the straps 400 inside the vehicle 102, and closing the side doors or the side windows on the end regions, thereby securing the window cover 100 to the vehicle 102. It should be apparent that the straps 400 may be of length, which enables the straps 400 to properly secure to the vehicle 102. For the purpose of this description, the straps 400 may have a length of about 4 to 6 inches.

It is important to note that thickness of the straps 400, particularly at the end regions, should be of such a size so as to facilitate an easy closing of the side doors or the side windows with the window cover 100 detachably covering the window 200.

As described above, a window cover, such as the window cover 100, of the present invention may be used to detachably cover a window of a vehicle, such as the window 200 of the vehicle 102, with the help of securing means that include magnets, such as the magnets 208; suction devices, such as the suction devices 212; and optionally, securing straps, such as the straps 400. It should be apparent that by the help of the securing means, the window cover serves as an effective shield to prevent or minimize a direct contact of snow, ice, rain, dust, etc., or other foreign matter, with the window.

Once the window cover is aligned over the window to detachably cover the window, snow and ice may accumulate over the window cover instead of directly accumulating over the window. Accordingly, when it is desired to clear or clean the window, the window cover may be removed from over the window. It should be understood that by use of the magnets and the suction devices, it becomes an easy task to remove the window cover that may carry snow and ice thereon. Once the window cover is removed, it may then be cleaned off, folded and stored away for a later use. In such a way, there is no requirement of a conventional scraper or any other assisting means for removing snow and ice from over the window. Therefore, the window cover of the present invention serves to protect the window from accumulations of snow and ice thereon, thereby saving a user's or a vehicle owner's time, and effort, for a tedious and messy clearing and cleaning of the window during inclement winter weather. It should be understood that the window cover may also be used for protection of the window against rain, dust, dirt, debris, or other foreign matter.

Based on the foregoing, the present invention provides an effective shielding system in the form of a window cover for protecting a window of a vehicle against snow and ice during inclement winter weather. More specifically, the window cover is capable of protecting a windshield and/or a rear window of the vehicle. Further, the window cover is capable of protecting the window against freezing rain, dirt, dust, debris or other foreign matter, in addition to snow and ice. As disclosed above, the window cover includes a structurally strong flexible sheet, magnets and suction devices. By way of employing the magnets and the suction devices, it is easy and convenient to use the window cover to detachably cover the window of the vehicle when snow and icing conditions are anticipated. Further, such a detachable covering also allows for an easy and convenient removal of the window cover after use, from the window, thereby preventing any damage to the window.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and thereby enable others skilled in the art to best utilize the invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. A window cover for protecting a window of a vehicle during inclement winter weather, the window cover comprising:
a flexible sheet for detachably covering the window, the flexible sheet comprising,
a first surface facing the window, and
a second surface capable of being exposed to the inclement winter weather;
a plurality of magnets configured on the first surface of the flexible sheet, the plurality of magnets capable of being securely attached to a first portion of the vehicle for enabling the flexible sheet to detachably cover the window; and
a plurality of suction devices configured on the first surface of the flexible sheet, the plurality of suction devices capable of being securely attached to a second portion of the vehicle for enabling the flexible sheet to detachably cover the window.

2. The window cover of claim 1, wherein the window is at least one of a front window, a rear window and a side window.

3. The window cover of claim 1, wherein the flexible sheet is a sheet of tarp.

4. The window cover of claim 3, wherein the flexible sheet is a multi-layered sheet of tarp.

5. The window cover of claim 1, wherein the flexible sheet is resistant to snow, water and ice.

6. The window cover of claim 1, wherein the first portion of the vehicle is an outside portion of roof of the vehicle.

7. The window cover of claim 1, wherein the first portion of the vehicle is an outside portion of hood of the vehicle.

8. The window cover of claim 1, wherein the first portion of the vehicle is an outside portion of a metallic body of a side door of the vehicle.

9. The window cover of claim 1, wherein the second portion of the vehicle is an outside portion of the window.

10. The window cover of claim 1, wherein the second portion of the vehicle is an outside portion of hood of the vehicle.

11. The window cover of claim 1, wherein the second portion of the vehicle is an outside portion of roof of the vehicle.

12. The window cover of claim 1 further comprising a plurality of securing straps configured to the flexible sheet, wherein the plurality of securing straps enable the flexible sheet to detachably cover the window.
